(19) United States
(12) Patent Application Publication
(10) Pub. No.: US 2017/0173912 A1
(43) Pub. Date: Jun. 22, 2017

(54) COLLAPSIBLE BOX MAKING EQUIPMENT

(71) Applicant: BRIAN JEFF GOTTLIEB, Toronto (CA)

(72) Inventor: BRIAN JEFF GOTTLIEB, Toronto (CA)

(21) Appl. No.: 14/979,096

(22) Filed: Dec. 22, 2015

(51) Int. Cl. B31B 5/26; B31B 5/60; B31B 5/02

(52) U.S. Cl. CPC B31B 5/26; B31B 5/02; B31B 5/60; B31B 2203/006; B31B 2203/066; B31B 2203/084

(57) ABSTRACT

A manufacturing process to produce a collapsible box, wherein a prefabricated cardboard having a plurality of collapsing lines along a center line and a plurality of scoring lines, wherein said center line divided the prefabricated cardboard into two parts, wherein said process comprises of steps of feeding section to feed said prefabricated cardboard sheet into an apparatus; folding section to fold a set of wings along said scoring line in the cardboard sheet; dispensing section to dispense an adhesive to an adhesive line; collapsing section to form the cardboard into a collapsing box by pushing a mandrel downwardly into said collapsing lines; and rolling section to compress the collapsing box.

### FIELD OF THE INVENTION

The present invention relates generally to packaging and especially to collapsible boxes.

### BACKGROUND OF THE INVENTION

A recent trend in most industries is towards sustainable manufacturing, which involves new interpretations and approaches to consumer products and their packaging. To be effective in this new age of sustainability, manufactures will have to consider solutions carefully, and ensure that the environmentally friendly mindset comes from the top down, and in many aspects of their business.

Cardboard boxes are commonly used in packaging industry. By improvement in manufacturing technology and materials, cardboard boxes now have better strength and can handle more weights. One issue in using cardboard boxes are their volume during the shipment. Even the cardboard boxes which are foldable can be piled in a relatively volume saving manner. However, still foldable boxes need a fastening means, such as adhesive tape and/or stapling device, to fix the shape of the box. In addition, preparation of a folded box for use is time consuming and, therefore, costly.

Collapsible boxes are one of the options for solving the above problems. Collapsible cardboard boxes have high strength characteristics, and they are easy to pack, transport and re-construct. The steps for manufacturing the collapsible boxes are different than the traditional ones. Although, the cost for manufacturing of collapsible boxes is slightly higher than the traditional ones, however, the convenience and future savings justifies their use.

Currently designers and engineers are looking for more economical methods for manufacturing collapsible boxes, to make them affordable for all groups of people. There are several methods for manufacturing the collapsible boxes which are discussed in the prior arts; however, the method presented here is optimized to provide for small number of extra steps for manufacturing such boxes.

### SUMMARY OF THE INVENTION

A collapsing box manufacturing machine to produce a collapsing box from a prefabricated cardboard sheet having a bottom panel, side panels connected to opposite sides of said bottom panel, front and back panels connected to opposite ends of said bottom panel, a pair of front wings each connected to a respective one of said side panels, and a pair of back wings each connected to a respective one of said side panels, said bottom panel, said front and back panels having a center line and said bottom panel having a plurality of collapsing-lines wherein each collapsing-line starting from the opposite ends of the bottom panel and ending on the centerline, and a push-center being a section at the middle of the centreline, said machine comprising:
a. a stationary frame having a plurality of active rollers to move said prefabricated cardboards along said machine in a longitudinal direction to provide a moving-cardboard wherein said front panel is aligned along the longitudinal direction;
b. a positioning and feeding station, wherein said prefabricated cardboards are positioned, aligned, and fed one at a time into said machine;
c. a folding station having:
   i—a pair of lifting means having a predefined position with respect to the moving cardboard to lift up said front wings;
   ii—a crosswisely positioned folding-rod having a predefined height with respect to the moving cardboard to fold the lifted front wings by 180 degrees while the cardboard roles underneath the folding-rod;
d. a pair of weight-panels to hold the front wings in the folded positions while the cardboard moves along the machine from the folding station to a collapsing station;
e. a gluing station to apply glue to said front and back panels;
f. said collapsing station comprising:
   i. a pair of jacks to lift up the pair of back wings;
   ii. a mandrel having a head to push down said push-center of said cardboard;
   iii. a pair of round disks located longitudinally on the centerline, said disks having a predefined gap to allow for the mandrel to freely move between them, said round disks having a top and a bottom;
   iv. a pair of first rollers located longitudinally on two sides and close to the top of said round disks, said roller having a predefined first-roller-spacing to fold the cardboard while the cardboard is collapsing, whereby back sides of said front and back wings glue to the said front and back panels, respectively; and
   v. a pair of second rollers located longitudinally on two sides and close to the bottom of said round disks to press the collapsing box to spread the glue,
whereby a collapsing box is formed at the end of the machine.

The present invention is a method and an apparatus for manufacturing a collapsible box from a prefabricated cardboard sheet. First a cardboard sheet is cut to a proper shape and size, and collapsing lines are generated in the proper locations. The proper cardboard sheet has a bottom panel, side panels connected to opposite sides of said bottom panel, front and back panels connected to opposite ends of said bottom panel, a pair of front wings each connected to a respective one of said side panels, and a pair of back wings each connected to a respective one of said side panels. The bottom panel, and the front and the back panels have a centre line and said bottom panel has a plurality of collapsing line along the centre line.

The method of manufacturing comprises of positioning said prefabricated cardboard sheet in a proper position; folding said pair of front wings and holding the folded front wings; gluing said front and back panel while keeping said front wings; lifting said pair of back wings up; and collapsing said bottom panel along said collapsing line with a downwardly moving mandrel and a set of wheels underneath the cardboard sheet align with said centre line.

The present apparatus for manufacturing a collapsible cardboard box utilizes the above described prefabricated cardboard sheet. The apparatus comprises of a stationary frame; means for feeding a prefabricated cardboard sheet into said apparatus; means for positioning said prefabricated cardboard sheet in a proper position; means for folding said pair of front wings; means for holding said folded front wings; means for gluing said front and back panels; means for collapsing said bottom panel along said collapsing line; and means for rolling said collapsing box.

The present invention provides collapsible boxes which are pre-assembled with the capability of quickly erecting and collapsing. It offers a fast solution for opening a box that can be collapsed to flat and reopened again. The box is pre-built to eliminate and reduce the setup time for preparation of the boxes. Collapsible boxes are pre-assembled and pre-formed and ready to use with the specific design. The collapsible boxes are easy to open and collapse.

One objective of the present invention is to provide a collapsible box which is pre-assembled and eliminates the time for assembly of the box.

The second objective of the present invention is to provide a collapsible box which is reusable several times.

The third objective of the present invention is to provide a collapsible box having a solid bottom and double wall-sides for greater strength.

Other objects, features, and advantages of the present invention will be readily appreciated from the following description. The description makes reference to the accompanying drawings, which are provided for illustration of the preferred embodiment. However, such embodiments do not represent the full scope of the present invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a plan view of the pre-shaped cardboard sheet used in the present invention;

FIG. 2 shows a front view of the manufacturing apparatus used in the present invention;

FIG. 3 shows a perspective view of the manufacturing apparatus used in the present invention;

FIG. 4 shows a perspective view of the first station in the manufacturing apparatus used in the present invention;

FIG. 5 shows a perspective view of the second station in the manufacturing apparatus used in the present invention;

FIG. 6 shows a perspective view of the third station in the manufacturing apparatus used in the present invention;

FIG. 7 shows a perspective view of the forth station in the manufacturing apparatus used in the present invention;

FIG. 8 shows a perspective view of the forth station in the manufacturing apparatus used in the present invention; and

FIG. 9 shows a perspective view of the fifth station in the manufacturing apparatus used in the present invention.

### DETAILED DESCRIPTION OF PREFERRED EMBODIMENTS

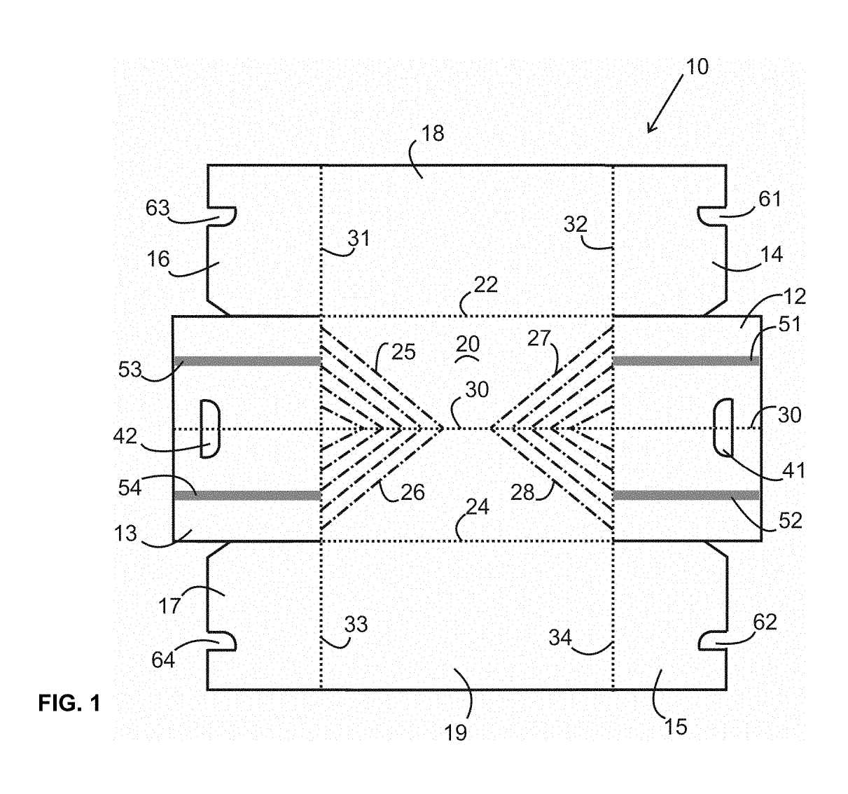

FIG. 1 shows a plan view of cut-out of the cardboard sheet 10 used to produce a collapsible box. The cardboard sheet 10 comprises of a front panel 12, a back panel 13, a set of front wings 14-15, a set of back wings 16-17, a side-top panel 18 and a side-bottom panel 19 and a bottom panel 20. The bottom panel 20 comprises of four foldable edges 21-24. The bottom panel 20 also has a plurality of collapsing lines 25-28. The bottom panel 20 further has a half line 30 in the centre of the bottom panel 20. The collapsing line 25-28 helps for collapsing the bottom panel 20 during the manufacturing process. The cardboard sheet 10 further has four extra folding lines 31-34 between the panels 16 and 18, 14 and 18, 17 and 19 and 15 and 19. There are two cut-outs 41-42 designed in the front panel 12 and the back panel 13.

The adhesive lines 51-54 are shown in the front panel 12 and the back panel 13. An adhesive is applied to the front and back panels 12-13 during the manufacturing process to combine the relative panels together. During the manufacturing process the applied adhesive binds the back side of the set of front wings 14-15 to the front panel 12 and the set of back wings 16-17 to the back panel 13. Two sets of front and back wings 14-17 have a cut-out 61-64 that after binding with the front panel 12 and back panel 13 are aligned by the cut-outs 41-42.

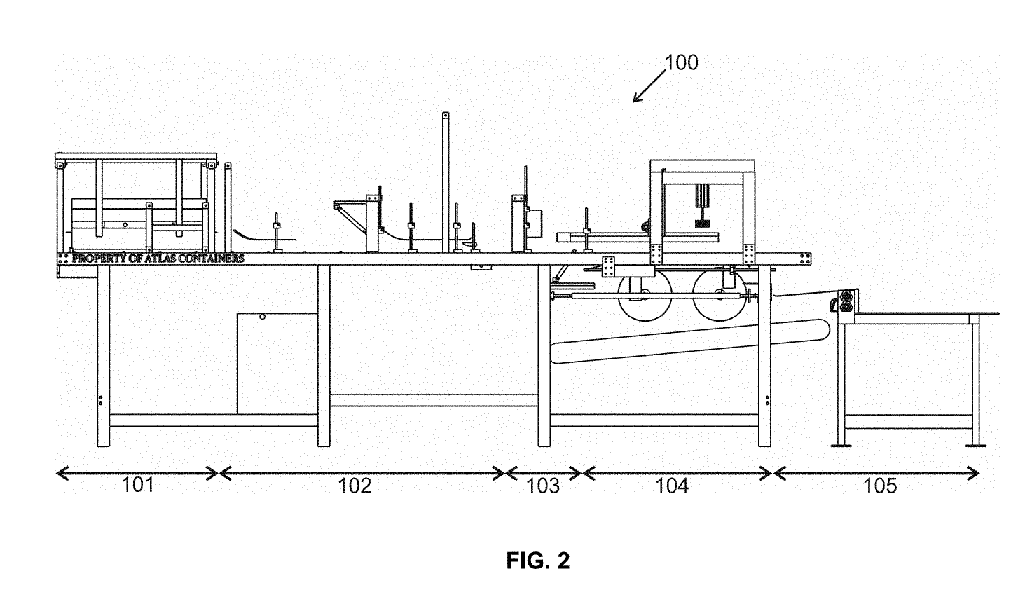

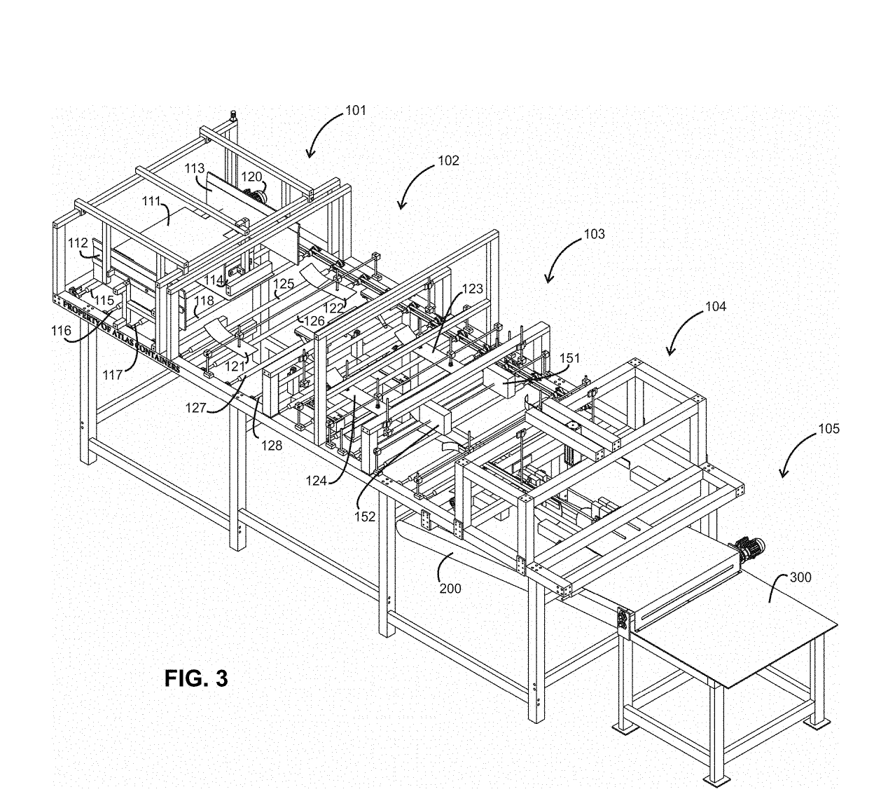

A manufacturing process for producing a collapsible box is shown in FIGS. 2-3. The process for manufacturing is divided into five steps. The consequence for manufacturing of the collapsible box starts from the first step 101 in the distal end of the apparatus 100 to the fifth step 105 in the proximal end of the apparatus 100.

In the manufacturing process, positioning of the prefabricated cardboard sheet in the apparatus is done by a plurality of sensors to check the location and the movement of the prefabricated cardboard sheet along a production line. For the person skilled in the art, the positioning of the sheets in tracking the location of the sheets can be done by different methods.

Again as shown in FIGS. 2-3, the manufacturing process for producing a collapsible box comprises of following steps:
Feeding section 101 to feed the cardboard sheets into the apparatus 100;
Folding section 102 to fold some panels of the cardboard sheets;
Glue Dispensing section 103 to dispense the glue into the glue line in the panels;
Collapsing section 104 which applies a push force into the cardboard sheet and folds it in a specific order; and
Rolling section 105 to apply a pressure to spread the glue in the desired parts in the panels.

As shown in FIGS. 2-4, the first section 101 in the apparatus 100 is feeding section 101. In the feeding section 101, the scoring sheets 10 as shown in FIG. 1 with the folding line are placed in the feeding line 111. The feeding line 111 is designed in such a way to transfer the sheets in a right position and alignment to the next section 102. The user or machine can place the sheets in a proper position as shown in FIG. 1 in the feeding line 111.

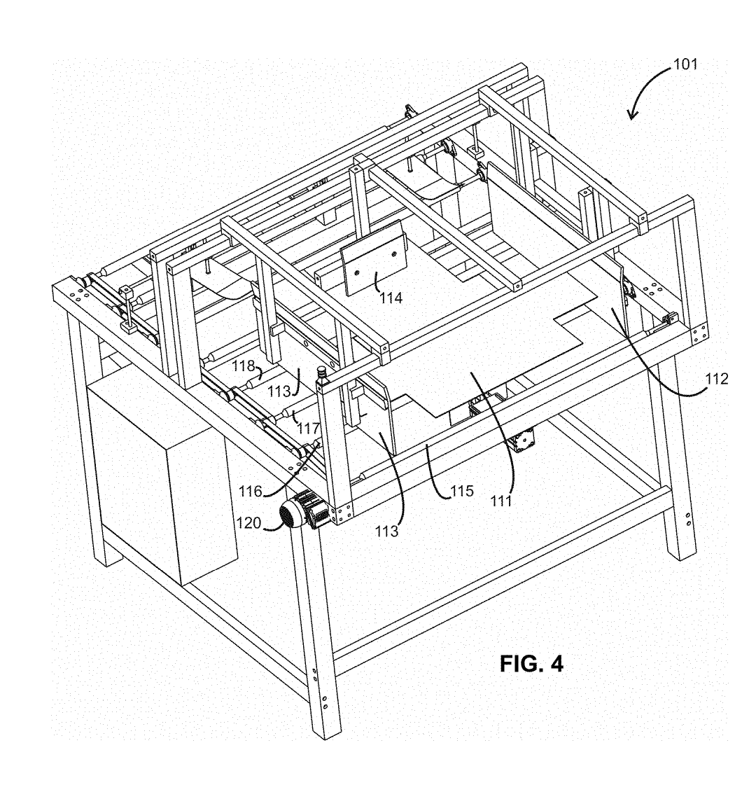

Again as shown in FIGS. 3-4, the feeding section 101 having a feeding line 111 to place the cardboard sheets in a proper alignment. For making sure that the cardboard sheets are in a proper position, there are three alignment planes 112-114 which help the user to make sure that the sheets are in a right way for the next step. The feeding section 101 also has a plurality of rollers 115-118 push the sheets into the second step 102. An electric motor 120 drives the rollers 115-118 in the feeding section 101.

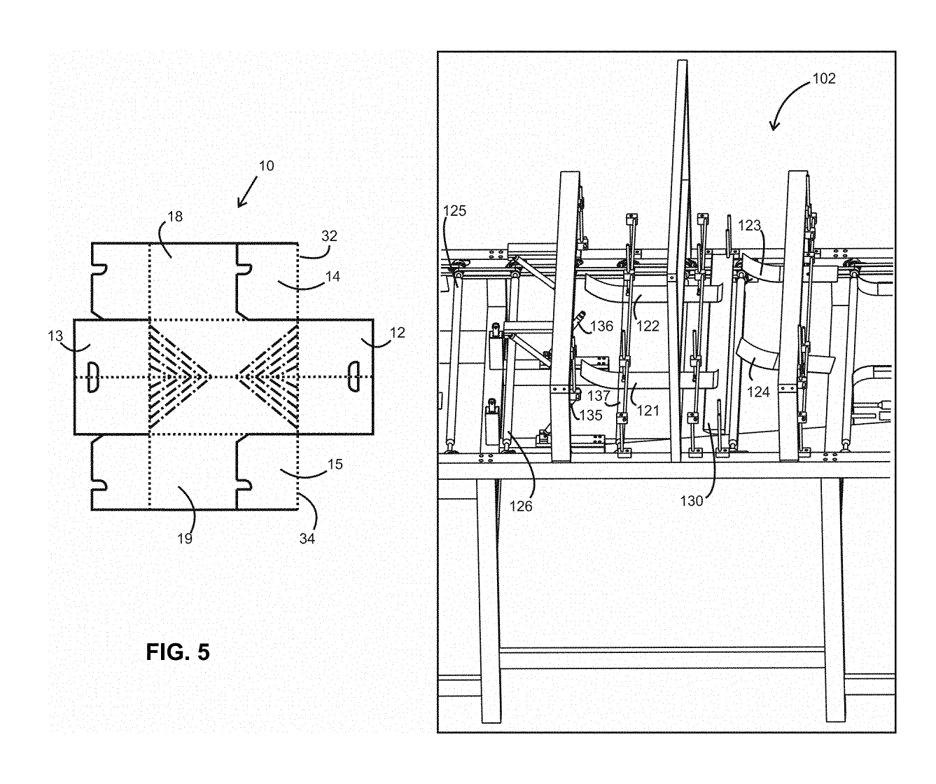

At the end of the feeding line 101, the cardboard sheets with the specific alignment are introduced into the second section 102 which is the folding section 102. As shown in FIGS. 2-3 and 5, the folding section 102 comprising of steps to fold the set of front wings 14-15 in the folding lines 32 and 34. In the folding section 102, there is a plurality of holding weights 121-124 designed in the folding section 102 to keep the cardboard sheet in a proper location and also keep all edges of the sheets lie in the folding line. A plurality of rollers 125-128 navigates the cardboard sheet in the folding section 102. A lifting edge 130 in the folding section 102 lifts the set of front wings 14-15 and bends them to align the score lines 32 and 34. After the folding, a set of holding weights keep the folded wings in the fold position. The whole process of the collapsible box manufacturing is continuous and the steps are preceded continuously during the processing lines.

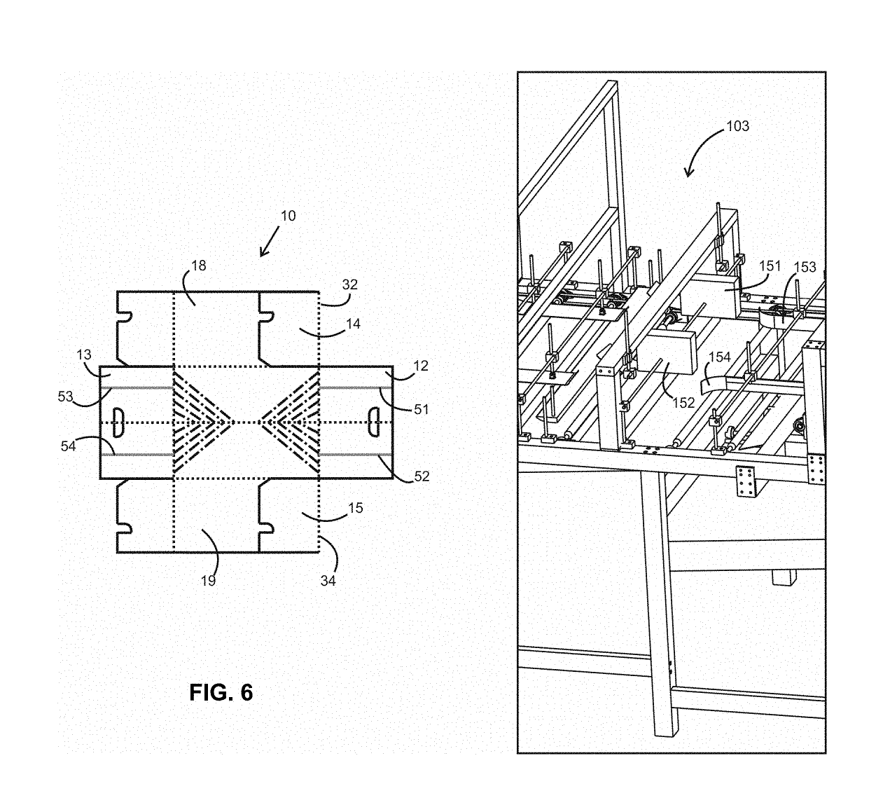

As shown in FIGS. 2-3 and 6, the cardboard sheet travels to the glue dispensing section 103 while the set of front wings 14-15 are in the folded position. The glue dispensing section comprises of a glue pump (not shown) and a set of glue nuzzles 151-152, which sense the existence of the sheet and dispense glue (hot or cold glue) into the glue lines 51-54 in front and back panels 12-13 (as shown in FIG. 1). The patterns for applying the glue into the panels 12-13 can vary based on the material of the glue and the surface characteristic of the cardboard sheets. After dispensing the glue in the glue lines, the navigating arms 153-154 navigate the sheet to the collapsing section 104.

In the method of manufacturing of the collapsible box the glue can be selected from different source of glue such as a cold glue and a hot glue, based on the thickness and the weight of the cardboard sheets.

During the manufacturing process, the alignment and the location of the sheet in the apparatus is controlled by pluralities of rollers and weight holders and sensors to make sure that the specific function is applies to the sheet in a proper order.

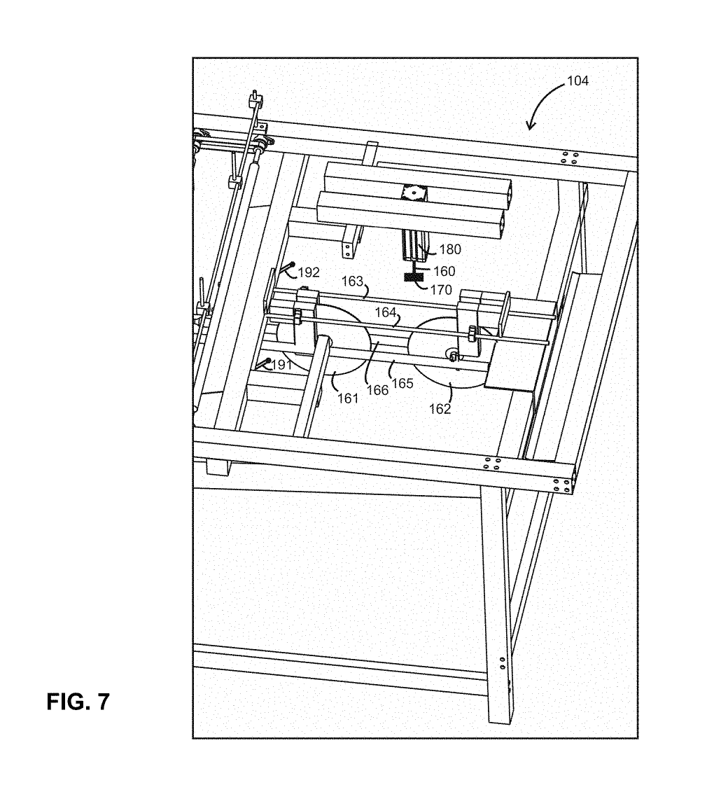

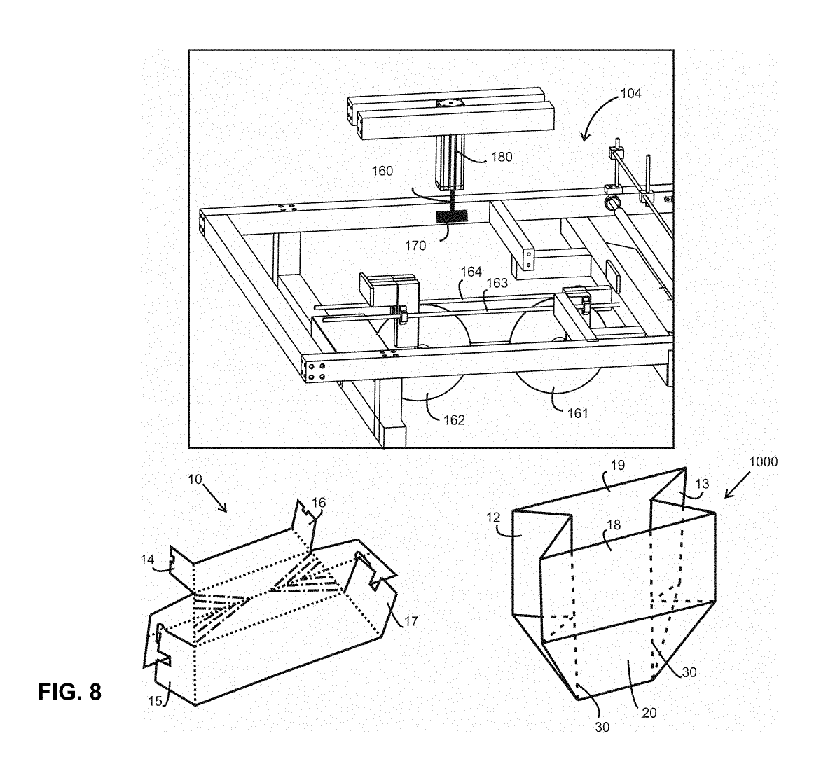

As shown in FIGS. 2-3 and 7-8, the most important part of the manufacturing process to produce a collapsing box is done in the collapsing section 104. In the collapsing section, the whole process of forming the box is competed in a single step, which is the main novelty of the present invention.

Again as shown in the FIGS. 2-3 and 7-8, the cardboard sheet goes throw the collapsing section 104, where a specific mandrel 160 pushes the sheet downward on the middle of the sheet aligned at the centre line 30 between a set of wheels 161-162 and two sets of rollers 163-164 and 165-166 precisely at a designed score lines that allows for all the foldable panels to meet and adhere.

After passing through the glue dispensing section 103, the holding weights 121-124 releases the folded wings 14-15, and because of the spring characteristic of the cardboard sheet, the folded wings 14-15 stands almost in the right angle position, and also the set of back wings 16-17 stand simultaneously with the help of a set of pushing jacks having a 45° angle that pushes and holds the wings 16-17 at almost a right angle until the distal end 170 of the mandrel 160 pushes the sheet.

The mandrel 160 has a distal end 170 and moves precisely downward with the help of a pneumatic pump 180. The distal end 170 of the mandrel 160 pushes down the centre line 30 precisely between the two sets of collapsing lines 25-28. As shown in FIGS. 1, 7 and 8, by pushing down the sheet at the top of the wheels 161-162, the sheets fold along the scoring line of 30, and collapse along the collapsing lines 25-28. Before the collapsing happens, two sets of front and back wings 14-17 are in the right angled position and by pushing the distal end 170 of the mandrel 160, the sheet collapses along the collapsing line 25-28. Because there are two sets of rollers 163-166 designed around the two wheels 161-162, the sheet bends towards inside through the scoring line 30 and the back part of the wings 14-17 is pushed toward the centre of the sheet by the folded front and back panel 12-13, and is connected to the front and back panel 12-13 by the applied adhesive.

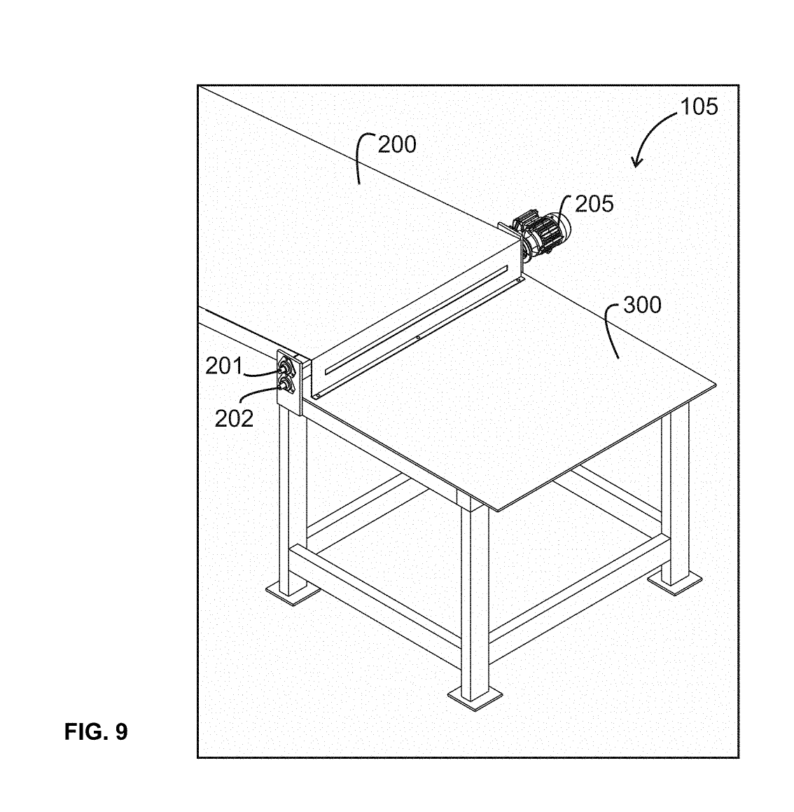

As shown in FIG. 9, after the collapsing section 104, the box travels on a conveyor 200 to the rolling section 105 and passes through a set of rollers 201-202, which are driven by a motor 205 to flatten. The rollers 201-202 apply pressure onto the box to help the adhesive (glue) to be even in every single corner of the applied area. The collapsible box stacks on the table 300 in the piles of 20 to 80.

As shown in FIGS. 1-9, a collapsing box manufacturing machine 100 to produce a collapsing box 1000 from a prefabricated cardboard sheet 10 having a bottom panel 20, side panels 18-19 connected to opposite sides of said bottom panel 20, front and back panels 12-13 connected to opposite ends of said bottom panel 20, a pair of front wings 14-15 each connected to a respective one of said side panels 18-19, and a pair of back wings 16-17 each connected to a respective one of said side panels 18-19, said bottom panel 20, said front and back panels 12-13 having a centreline 30 and said bottom panel 20 having a plurality of collapsing-lines 25-28 wherein each collapsing-line 25-28 starting from the opposite ends of the bottom panel 20 and ending on the centreline 30, and a push-center being a section at the middle of the centreline 30, said machine 100 comprising:
g. a stationary frame having a plurality of active rollers 115-119 to move said prefabricated cardboards 10 along said machine 100 in a longitudinal direction to provide a moving-cardboard wherein said front panel 12 is aligned along the longitudinal direction;
h. a positioning and feeding station 101, wherein said prefabricated cardboards 10 are positioned, aligned, and fed one at a time into said machine 100;
i. a folding station 102 having:
   iii—a pair of lifting means 135-136 having a predefined position with respect to the moving cardboard to lift up said front wings 14-15;
   iv—a crosswisely positioned folding-rod 137 having a predefined height with respect to the moving cardboard to fold the lifted front wings 15-16 by 180 degrees while the cardboard 10 roles underneath the folding-rod;
j. a pair of weight-panels 121-122 to hold the front wings 15-16 in the folded positions while the cardboard 10 moves along the machine 100 from the folding station 102 to a collapsing station 104;
k. a gluing station 103 to apply glue to said front and back panels 12-13;
l. said collapsing station 104 comprising:
   i. a pair of jacks 191-192 to lift up the pair of back wings 16-17;
   ii. a mandrel 160 having a head 170 to push down said push-center of said cardboard 10;
   iii. a pair of round disks 161-162 located longitudinally on the centerline, said disks 161-162 having a predefined gap to allow for the mandrel 160 to freely move between them, said round disks 161-162 having a top and a bottom;
   iv. a pair of first rollers 163-64 located longitudinally on two sides and close to the top of said round disks 161-162, said roller 163-164 having a predefined first-roller-spacing to fold the cardboard while the cardboard is collapsing, whereby back sides of said front and back wings 14-17 glue to the said front and back panels 12-13, respectively; and
   v. a pair of second rollers 165-166 located longitudinally on two sides and close to the bottom of said round disks 161-162 to press the collapsing box 1000 to spread the glue,
whereby a collapsing box 1000 is formed at the end of the machine 100.

The present process of manufacturing collapsible boxes is very compact and more economical as compared to the common manufacturing processes for the collapsible box. The specific design in the mandrel, set of wheels and two sets of rollers in the collapsing section, make the present invention unique and novel.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A collapsing box manufacturing machine to produce a collapsing box from a prefabricated cardboard sheet having a bottom panel, side panels connected to opposite sides of said bottom panel, front and back panels connected to opposite ends of said bottom panel, a pair of front wings each connected to a respective one of said side panels, and a pair of back wings each connected to a respective one of said side panels, said bottom panel, said front and back panels having a center line and said bottom panel having a plurality of collapsing-lines wherein each collapsing-line starting from the opposite ends of the bottom panel and ending on the centerline, and a push-center being a section at the middle of the centerline, said machine comprising:
a. a stationary frame having a plurality of active rollers to move said prefabricated cardboards along said machine in a longitudinal direction to provide a moving-cardboard wherein said front panel is aligned along the longitudinal direction;
b. a positioning and feeding station, wherein said prefabricated cardboards are positioned, aligned, and fed one at a time into said machine;
c. a folding station having:
i. a pair of lifting means having a predefined position with respect to the moving cardboard to lift up said front wings;
ii. a crosswisely positioned folding-rod having a predefined height with respect to the moving cardboard to fold the lifted front wings by 180 degrees while the cardboard roles underneath the folding-rod;
d. a pair of weight-panels to hold the front wings in the folded positions while the cardboard moves along the machine from the folding station to a collapsing station;
e. a gluing station to apply glue to said front and back panels;
f. said collapsing station comprising:
i. a pair of jacks to lift up the pair of back wings;
ii. a mandrel having a head to push down said push-center of said cardboard;
iii. a pair of round disks located longitudinally on the centerline, said disks having a predefined gap to allow for the mandrel to freely move between them, said round disks having a top and a bottom;
iv. a pair of first rollers located longitudinally on two sides and close to the top of said round disks, said roller having a predefined first-roller-spacing to fold the cardboard while the cardboard is collapsing, whereby back sides of said front and back wings glue to the said front and back panels, respectively; and
v. a pair of second rollers located longitudinally on two sides and close to the bottom of said round disks to press the collapsing box to spread the glue,
whereby a collapsing box is formed at the end of the machine.

2. The collapsing box manufacturing machine of claim 1, said feeding station further having a push jack to feed one cardboard at a time from a stack of cardboards into said machine.

3. The collapsing box manufacturing machine of claim 1, wherein said glue is selected from the groups of a cold glue and a hot glue.

4. The collapsing box manufacturing machine of claim 1, further having a plurality of sensors to check the location and the movement of said prefabricated cardboard sheet in the frame.

5. The collapsing box manufacturing machine of claim 1, wherein each said weight panel is an elongated metal piece attached to the frame having a adjustable means to adjust the gap between the moving rollers and the with bar.

6. The collapsing box manufacturing machine of claim 1, wherein said active roller being rotated by a motor which is connected to said roller through a belt.

7. The collapsing box manufacturing machine of claim 1, wherein said lifting means are a pair of jacks to push the wings upward as soon as the wings are positioned on the top of the jacks.

8. The collapsing box manufacturing machine of claim 7, wherein said jack having a roller tip to allow for easy movement of the cardboard.

9. The collapsing box manufacturing machine of claim 1, wherein the head of said mandrel being rectangular or ellipsoidal with its longer length along the centerline of said cardboard.

10. The collapsing box manufacturing machine of claim 1, wherein the diameter of said round disk being the same as the longitudinal length of said bottom panel.

11. The collapsing box manufacturing machine of claim 1, wherein said first-roller-spacing being the same as the thickness of said collapsing box.

12. A method of manufacturing a collapsible box from a prefabricated cardboard sheet having a bottom panel, side panels connected to opposite sides of said bottom panel, front and back panels connected to opposite ends of said bottom panel, a pair of front wings each connected to a respective one of said side panels, and a pair of back wings each connected to a respective one of said side panels, said bottom panel, said front and back panels having a center line and said bottom panel having a plurality of collapsing line along said center line, the method comprising:
a. positioning said prefabricated cardboard sheet on a plane wherein said front panel of said sheet is aligned to the right side of the plane;
b. applying glue along said front and back panels on both sides of said centerline;
c. lifting said pair of front and back wings up by 90 degrees using a lifting means; and
d. pushing down on the center of said centerline using a mandrel while holding the remainder of the centerline using a pair of round disks and holding the side panels by a pair of longitudinal rollers, thereby collapsing said bottom panel while folding the side panels along said collapsing line.

13. The method of manufacturing a collapsible box of claim 12, wherein said method having further step of compressing the collapsible box by a pair of rollers to transversely compress all section of the collapsible box.

14. A method of manufacturing a collapsible box from a prefabricated cardboard sheet having a bottom panel, side panels connected to opposite sides of said bottom panel, front and back panels connected to opposite ends of said bottom panel, a pair of front wings each connected to a respective one of said side panels, and a pair of back wings each connected to a respective one of said side panels, said bottom panel, said front and back panels having a center line and said bottom panel having a plurality of collapsing line along said center line, the method comprising:
a. positioning said prefabricated cardboard sheet on a plane wherein said front panel of said sheet is aligned to the right side of the plane;
b. folding said pair of front wings by 180 degrees and holding the folded front wings using a pair of weights;
c. applying glue along said front and back panels on both sides of said centerline;
d. lifting said pair of back wings up by 90 degrees using a pair of jacks and removing the weights from said pair of front wings to allow them to lift up, and
e. collapsing said bottom panel along said collapsing line with a downwardly moving mandrel perpendicular to said prefabricated cardboard sheet, wherein said mandrel is engaged with the center of said centerline, and holding the side panels with a pair of rollers while the center of the cardboard is collapsing;

15. The method of manufacturing a collapsible box of claim 14, wherein said method having further step of compressing the collapsible box by a pair of rollers to transversely compress all section of the collapsible box.
